(19) United States
(12) Patent Application Publication
(10) Pub. No.: US 2026/0178014 A1
(43) Pub. Date: Jun. 25, 2026

(54) MANUFACTURING AND FACILITY MANAGEMENT SUPPORT SYSTEM USING MULTIPLE LARGE LANGUAGE MODELS BASED ON ACTUAL SYSTEM CONFIGURATION

(71) Applicant: Mitsubishi Electric Corporation, Tokyo (JP)

(72) Inventor: Taishi ANDO, Tokyo (JP)

(73) Assignee: Mitsubishi Electric Corporation, Tokyo (JP)

(21) Appl. No.: 18/986,816

(22) Filed: Dec. 19, 2024

(51) Int. Cl. G05B 19/418; G06F 16/3329

(52) U.S. Cl. CPC G05B 19/41865; G05B 19/41885; G06F 16/33295

(57) ABSTRACT

A large language model (LLM) twin system can include a user interface to receive a query from a user, a Digital Twin to simulate and verify parameters of each of a plurality of devices of a factory, and a plurality of LLM Agents including a Manager Agent for controlling and communicating with the other LLM Agents and for receiving the query, interpreting the query using one or more of the LLM Agents to update the query, sending the update query to one or more of the other LLM Agents to receive an answer to the query, receiving the answer from the one or more other LLM Agents, and sending the answer to the user through the user interface.

The present disclosure may be regarded as being directed to systems and methods that can implement multiple Agents working together, particularly where such multiple Agents can use multiple Large Language Models (LLMs) and/or Small Language Models (SLMs) designed or configured based on actual system configuration of factories and facilities.

### SUMMARY

According to an aspect, an LLM twin system includes a user interface configured to receive a query from a user, a Digital Twin configured to simulate each of a plurality of devices of a factory, a plurality of LLM Agents, including a Manager Agent configured to communicate with the other LLM Agents among the plurality of Agents and the Digital Twin, in response to a user inputting the query into the user interface, the Manager Agent is configured to interpret the query using one or more of the LLM Agents to update the query, send the updated query to one or more of the other LLM Agents to receive an answer to the query, receive the answer from the one or more other LLM Agents, and send the answer to the user through the user interface.

According to another aspect, an LLM twin system includes a user interface configured to receive a query from a user, a Digital Twin configured to simulate each of a plurality of devices of a factory, and a plurality of LLM Agents, including a Manager Agent configured to communicate with the other LLM Agents among the plurality of Agents and the Digital Twin, and a Motion LLM configured to control the plurality of devices in the factory, including the processing path(s) and control parameters through Supervisory Control and Data Acquisition (SCADA) software, in response to a user inputting the query into the user interface and the query being a request for manufacturing plans for an item to produce, the Manager Agent is configured to search and determine the item to produce, automatically produce a product design based on the determined item, including forming a process image, transfer the product design to the Motion LLM to generate a processing path, receive the processing path from the Motion LLM, and use the generated product design and processing path to produce the product in the factory.

Yet another aspect includes an LLM twin system including a user interface configured to receive a prompt from a user, a Digital Twin configured to simulate each of a plurality of devices of a factory, and a plurality of LLM Agents, including a Manager Agent configured to communicate with the other LLM Agents among the plurality of Agents and the Digital Twin, a Specialist Agent, a Machine Agent, and a Line Agent, the Specialist Agent is configured to be trained on data regarding modification of setting from the specifications in order to operate the plurality of devices, the Machine Agent is configured to store and analyze data from each of the plurality of devices to optimize the operation of the plurality of devices, the Line Agent is configured to manage an entire production line of the factory and to optimize productivity in real-time, and in response to the user inputting the query into the user interface, the Manager Agent is configured to interpret the query using one or more of the LLM Agents to update the query, send the update query to one or more of the other LLM Agents to receive an answer to the query, in response to the query being related to a function of one of the plurality of device of the factory, request the Digital Twin to simulate the answer from the one or more LLM Agents to verify the answer, and receive the verified answer from the Digital Twin and send the verified answer to the user through the user interface.

### BRIEF DESCRIPTION OF THE DRAWINGS

Aspects of the present disclosure will become more fully understood from the detailed description given hereinbelow and the accompanying drawings which are given by way of illustration only, and thus are not necessarily limitative.

FIG. 1 is a diagram of an overall LLM Twin system configuration according to one or more embodiments of the present disclosure.

FIG. 2 is a diagram of the internal structure of a representative Agent (e.g., Device Agent), showing how the LLM, tool execution capabilities, and memory functions can be integrated, according to one or more embodiments of the present disclosure.

FIG. 3 is an LLM switching flowchart showing the flow of switching between local LLMs and open LLMs by the user interface, including the operation of the AI-based primary decision-making system, according to one or more embodiments of the present disclosure.

FIG. 4 is a flowchart showing how the Digital Twin collects real-time data, performs simulations, and works in conjunction with the LLM Twin to utilize the results, according to one or more embodiments of the present disclosure.

FIG. 5 is a diagram illustrating how initial Agents are set up and evolve by incorporating user data over time, according to one or more embodiments of the present disclosure.

FIG. 6 is a diagram of problem solving using an LLM Twin system according to one or more embodiments of the present disclosure.

FIG. 7 is a diagram of a process troubleshooting an error according to one or more embodiments of the present disclosure.

FIG. 8 is a flowchart of automatically determining a product to be produced based on market trends, according to one or more embodiments of the present disclosure.

### DETAILED DESCRIPTION

Aspects will now be described with reference to the accompanying drawings, wherein the same reference numerals have been used to identify the same or similar elements throughout the several views. Further, scope will become apparent from the detailed description given hereinafter. However, the detailed description and specific examples, while indicating embodiments of the present disclosure, are given by illustration only, since various changes and modifications within the spirit and scope of the present disclosure.

One or more embodiments of the present disclosure may be regarded as being directed to systems and methods that can implement multiple Agents working together, particularly where such multiple Agents can use multiple Large Language Models (LLMs) and/or Small Language Models (SLMs) designed or configured based on actual system configuration of a factory and facilities.

Systems and methods according to one or more embodiments of the present disclosure can be implemented particularly in the context of factory automation (FA) or building management (BM). Here, according to one or more embodiments of the present disclosure, representative Agents can be implemented for each piece of equipment and at multiple levels, according to actual system configuration of the overall system. For instance, one or more Agents can be implemented as a Twin (of the actual system) for each of an equipment level, a machine level, a line level, and a factory level, and each Agent can communicate directly with one or more other Agents. Such implementation may be regarded as a multi-language model (e.g., multi-large language model (LLM)) twin configuration of the actual system for access by a particular user.

In recent years, the introduction and use of generative AI technology in facilities and equipment, such as factories and office buildings, have been required due to labor shortages and difficulties in passing on technical knowledge. With advancements in generative AI models (LLMs), such as OpenAI's GPT-40® and Google's Gemini®, the scope of applications for these advancements has expanded. However, in fields like manufacturing (e.g., factory automation) and building management, application proposals remain limited to solutions, such as manual-based response bots and troubleshooting bots or offline support for optimizing parameters and control programs. Customization, adjustments, and management complexities during updates, reliability challenges, and security concerns have posed barriers to implementation of real-time manufacturing management and facility management across entire factories.

Given the complex tasks involved in using LLM-based agents for real-time data analysis or simulation execution, significant effort is required to tailor them to each user's environment. However, managing information updates for Agents is becoming overly complex. Additionally, if a single Agent is tasked with all knowledge and subtasking, as may be the case in existing methods, it often results in unnecessary information being included in every task, affecting response accuracy. High-performance LLMs often require cloud-based operation, raising concerns about data security and privacy. Therefore, there has been a demand for LLM technology specifically designed for factories and buildings that is easy to launch, easy to manage, secure, and capable of ensuring response accuracy.

An LLM can be regarded as a type of artificial intelligence (AI) program that can recognize and generate human language text, such as, but not limited to a user query (i.e., prompt) or request, among other tasks. They are trained on huge sets of data and LLMs are built on a type neural network called a transformer model. The neural network processes sequential data (e.g., processes entire sequences in parallel to reduce training time), such as text, based on the relationships between different parts of the input sequence. LLM's are trained on datasets of text and code, allowing them to understand and respond to complex prompts and questions in a human-like way. Transformer models apply mathematical techniques (i.e., attention or self-attention) to detect patterns between elements (i.e., patterns between data elements), as known in the art. Self-attention is a mechanism that relates different positions of a single sequence in order to compute a representation of the sequence encoder-decoder structure, where an encoder maps an input sequence of symbol representations to a sequence of continuous representations. Then the decoder can generate an output sequence of symbols one element at a time and at each step the model is auto-regressive, utilizing the previously generated symbols as another input when generating the next sequence. The self-attention function maps a query and a set of key-value pairs to an output, where the query, keys, values, and output are all vectors. The output is computed as a weighted sum of the values, where the weight assigned to each value is computed by a compatibility function of the query with the corresponding key.

Throughout the present specification, Small Language Model (SLM) can be used in replacement of, or together with, the recited LLM. Small Language Models (SLMs) can be regarded as a type of artificial intelligence model designed to process and understand human language. They are smaller and less complex than their larger counterparts, i.e., Large Language Models (LLMs), as they have fewer parameters (e.g., ranging from a few million to a few billion), which makes them more efficient and easier to train. SLMs are often designed for specific tasks, such as summarizing text, translating languages, or answering questions (e.g., solving problems with machinery or equipment). SLMs require less computational power and memory to run, making them suitable for deployment on smaller devices or even edge computing scenarios and can process information and generate responses more quickly than LLMs.

Applications of SLMs and LLMs according to one or more embodiments of the present disclosure can include on-device chatbots and virtual assistants to respond to user queries in real-time, as personalized mobile assistants that can help users with tasks such as troubleshooting, finding information, etc. for real-time data analysis to analyze large amounts of data in real-time and generate insights and to power AI-powered customer service systems that can answer customer questions and resolve issues.

One or more embodiments of the present application may be regarded as aiming to solve one or more of the aforementioned problems by providing a secure system that enables the rapid construction of LLM solutions tailored to specific factories and equipment, but can be used in a variety of applications. In general, the systems and methods can utilize an LLM Twin having Agents for each equipment, which can result in more accurate answers to user inquiries using data analysis and simulation. The Agents can communicate within themselves, for instance, using peer to peer encrypted communication, and can participate in execution of tasks associated with the objective of the service request or respond to a user query using encryption methods to communicate within themselves. Peer encrypted communication can include, but is not limited to, symmetric and asymmetric encryption.

According to one or more embodiments of the present disclosure, an “LLM Twin” system can include multiple Agents integrated and working together, and can be based on an actual system configuration, such as a manufacturing factory, facility or the like. A user interface can be provided, which can display one or more prompts to receive a user query. An input device, such as a keyboard, mouse, touch-screen display, microphone, and the like, can be provided for the user to provide the query to the LLM Twin system. Examples of such input devices include computers (i.e., personal), mobile/cellular phones/devices, handheld messaging devices, laptop computers, tablet computers, set-top boxes, personal data assistants, embedded computer systems, electronic book readers, and the like.

According to one or more embodiments of the present disclosure, the network can include any appropriate network, including an intranet, the Internet, a cellular network, a local area network, a satellite network or any other such network and/or combination thereof, and components used for such a system may depend at least in part upon the type of network and/or system selected. According to one or more embodiments of the present disclosure, communication over the network can be enabled by wired and/or wireless connections and combinations thereof. According to one or more embodiments of the present disclosure, the network can include the Internet and/or other publicly addressable communications network, as the system includes a web server for receiving requests and serving content in response thereto, although for other networks an alternative device serving a similar purpose could be used.

According to one or more embodiments of the present disclosure, upon the LLM Twin system receiving a query from a user (e.g., operator, customer or the like) via a user interface, multiple Agents with specific individualized roles and functions can collaborate to solve the problem of the user query, which may be in the form of a chat response. That is, upon receiving the query, the LLM twin may determine one or more answers to the query, and prompt follow-up questions to the user to more accurately determine which of the answers is most appropriate and may provide an answer (e.g., a solution) or multiple answer/solutions to the user depending on the situation.

The LLM twin according to one or more embodiments of the present disclosure can combine real-time data and Digital Twin technology when necessary, to allow for data analysis and simulation verification before providing answers in cases, such as troubleshooting. This can support advanced problem-solving and decision-making in manufacturing and facility management.

Digital Twin technology can refer to a virtual replica (e.g., digital model) of a physical object, person, system, or process, contextualized in a digital version of its environment that can perform real-time synchronization between physical and digital components. For instance, Digital twin technology can support real-time monitoring of equipment and machinery, enabling the early detection of issues and reducing response times, to improve stability and reliability of manufacturing and optimizing operations (e.g., factory operations) by integrating data collected from various machines/equipment and/or facilities and performing real-time analysis of this data. Digital twin technology can be a virtual representation that spans the object's lifecycle, is updated from real-time data (including manufacture data, device specific data, user data, past troubleshooting data, and the like) and uses simulation, machine learning, and reasoning to help make decisions. Real-time data can include data from sensors and other devices, system specifications, project files (e.g., imported data, parameters, project settings, etc.), operational data, maintenance data, troubleshooting data, Ladder theorem, video data and the like. Ladder theorem can refer to programming rules that are applied, which can utilize a graph design to represent a program. The graph design can be based on circuitry diagrams of relay logic hardware and can be utilized to develop software for programmable logical controllers (PLCs) used in industrial control applications, such as in factories. Digital Twin may also be referred to as a “digital shadow” or a “digital model.” Digital twin technology enhances connectivity and communication between various systems, optimizing production processes and enabling real-time monitoring and decision-making, and may be internet-based.

The overall system configuration according to one or more embodiments can include an LLM twin system with (open or local, as described below) multiple Agents, one or more Digital Twins, and a user interface. An LLM Twin system can be a virtual system composed of multiple Agents, designed based on the actual system configuration of factories and facilities. The Agents can be linked, including using small/individualized LLMs, and the Agents can work together to perform flexible problem-solving, by communicating via a digital pathway, including but not limited to a wired connection, such as via ethernet, fiber optic, or the like, or a wireless connection, such as Wi-Fi, Bluetooth, NFC and the like. The Digital Twin can recreate the operational status of real factories and facilities in a virtual environment using real-time data and allows the continuous monitoring of the system's status and enables predictions and simulations of system operations. Each Agent can integrate LLMs (e.g., local LLMs or open LLMs) with data context provided by retrieval-augmented generation (RAG), tool execution capabilities, and memory functions. This can allow the Agent to perform complex tasks, such as analyzing data based on manuals or real-time data and executing tasks using tools. Further, the user interface can allow a user to switch between local LLMs and open LLMs, selecting the optimal LLM for each situation. Additionally, the AI-based primary decision-making system can automatically select the optimal LLM or RAG based on the content of the query by the user.

The combination of the LLM twin, which links multiple Agents using small LLMs, and the Digital Twin can perform the function of conversation among Agents supporting each device to achieve high-level problem solving. The conversation between Agents includes consultation, discussion, request, verification, majority decision, role assignment, report and proposal. The result is an easier development because the Agents have divided roles and tasks, which improves the accuracy of answers to inquiries.

The LLM Twin can process textual, image, sensor, audio, and/or other data types. The system can be used for manufacturing and facility support systems, but is not limited thereto. The system can be for automotive systems (e.g., a control system for an autonomous or semi-autonomous machine, a perception system for an autonomous or semi-autonomous machine, etc.), performing synthetic data generation operations, operating robotics, aerial systems, medical systems, boating systems, smart area monitoring systems, systems for performing deep learning operations, systems for performing simulation operations, systems for performing Digital Twin operations, systems implemented using an edge device, systems incorporating one or more virtual machines (VMs), systems implemented at least partially in a data center, systems for performing light transport simulation, systems for performing collaborative content creation for 3D assets, systems implemented at least partially using cloud computing resources, and/or other types of systems.

### (2) Functions and Operations of Each Agent

When the system according to one or more embodiments of the present disclosure is applied to factory management (i.e., the management of a manufacturing factory), the LLM twin can include one or more of a Device Agent, a Machine Agent, a Line Agent, a Specialist Agent, a Factory Agent, and a Manager Agent. Optionally, the LLM twin may include additional agent types or less than all of the foregoing agent types. The Manager Agent can be regarded as a primary Agent that directly receives and responds to the query and can communicate with all of the Agents, calculate a possible solution and/or answer to the query based on data (e.g., in-house and user data) and confirm the possible solution with the Digital Twin and/or one or more of the other Agents.

In general, the Device Agent can respond to inquiries (e.g., user inquiries) related to each device; the Device Agent can also access (or have access to) relevant devices of the system through the Digital Twin, monitor the device's operational status, respond to inquiries using related documentation (e.g., manuals, operating information, real-time data and the like), and direct simulation executions to the Digital Twin. Each Device Agent can coordinate with other Agents within the LLM Twin to ensure a swift response to any problems. Optionally, each Agent can coordinate with other Agents within the LLM Twin to ensure a swift response to any problems. The system according to one or more embodiments of the present disclosure can include a different Agent for each machine and/or piece of equipment.

The Machine Agent can gather and analyze data to optimize the operation of equipment. The Machine Agent can access (or have access to) manuals and operational information related to the equipment and can make adjustments or proposals to improve operational efficiency.

The Line Agent can manage the entire production line and seek to enhance productivity in real-time. It can access (or have access to) layout plans and operational information of the line and make suggestions for improving overall production efficiency.

The Specialist Agent can represent roles that may desire or require advanced skills, such as factory maintenance personnel, data analysts, and programmers. The Specialist Agent can access (or have access to) knowledge resources like troubleshooting case history, data analysis methods, and programming rules specific to the user's organization. The Specialist Agent can solve problems using its expertise and relevant tools, including processing know-how, adjustment of various components, such as servos, motor, sensors and controls, etc.

The Factory Agent can oversee management of the entire factory, optimizing resource allocation, production scheduling, and coordination between lines, and the like.

The Manager Agent can act as an interface with users, coordinating the collaboration of various Agents and supporting overall operational efficiency. The Manager Agent can also provide decision-making support for flexible problem-solving.

Additional Agents can be used, such as a Marketing Agent 180 that gathers information from various sources, such as the Internet, to determine a current trend, such as a trendy product to be produced; a Product Planning and Design Agent 190 to generate the trend product and process path; and a Motion Agent 170 to use the generated processing path to generate control parameters. Implementing some or all of the foregoing additional Agents can allow for more full autonomous control of an entire process, from marketing to manufacturing.

Information (e.g., from skilled engineers that work in a factory and/or office building management) can be stored in memory and used to make “Specialist” Agents and can be added to an LLM Twin. The Specialist Agents can have characteristics of “know-how,” and corresponding tools are created for the Specialist Agents. “Know-how” can refer to information that is only known to skilled workers/skilled engineers that is used, for instance, to operate the machinery and/or other devices of the system. For instance, because the devices that incorporate servo motors can have various shapes depending on the user, it can be difficult to adjust the parameters so that no vibration occurs when performing any kind of operation, and skilled techniques are required. Experienced/skilled workers can determine the appropriate setting of parameters using intuition, feel, sight or by trial and error (i.e., skilled worker information). This skilled worker information from the skilled worker can be obtained by video footage and/or images/pictures obtained via a camera, output from a brain implant attached to the skilled worker, digital glasses, touch sensors included the machinery/devices and the like. Such skilled worker information may be regarded as information of the type not normally obtained in an owner's manual, troubleshooting manual, or other source material.

When the LLM Twin is applied to office building management, the LLM Twin can include Agents that correspond to the various components of an office building, such as, but not limited to, an Air Conditioning Agent, a Lighting Agent, an Elevator Agent, a Building Agent, and a Manager Agent. Each Agent can have a different role, and each Agent can have knowledge of its own area of responsibility. By separating the management into a plurality of Agents, the development of the system can be simplified and the database (e.g., the data to be stored in the Agent) can be minimized.

According to one or more embodiments of the present disclosure, each Agent can be initially created based on internal documents and/or other data, and user's data can be collected in return and provided to the Agents. The Agents can be continuously updated with new data (e.g., user's data and the like) to improve the Agents' ability to respond to question(s) by user(s) or solve problems, such as a problem with one of the components of the system. A framework can be established to utilize user-owned data, such as project files, operation data, maintenance data, troubleshooting data, know-how data (e.g., skilled worker information) and the like. Such a utilization can allow for a cycle to be established in which Agents are improved by collecting and learning user's data. That is, data can be continuously being collected and stored in the corresponding Agent to improve the Agent's ability to response to inquiries/prompts, thus improving the output of the Agents.

Communication between the Agents of a system can be performed by a multi-agent platform, such as CrewAIR Autogen® or any other known framework that is designed to orchestrate, optimize and automate a plurality of Agents, and can allow for the creation of complex, multi-agent conversations and problem solving that are conducted in an automated manner. That is, in response to a user query or prompt, the multi-agent platform can allow for the various Agents of a system to communicate to resolve a problem or answer a query. That is, using such a framework, the Agents can collaborate to generate more comprehensive and informative responses, due to LLM Agents being assigned to specific roles, which can allow the LLM Agents to collaborate effectively and divide tasks.

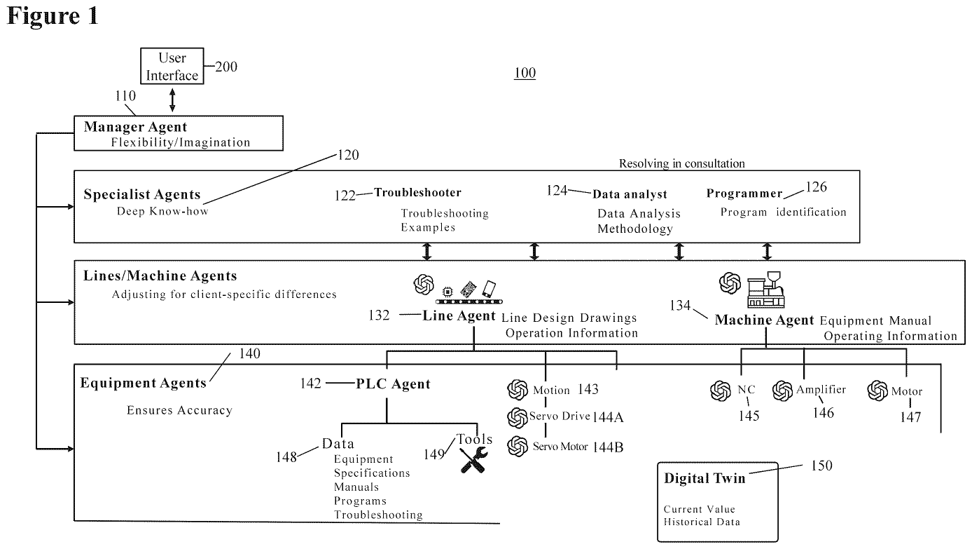

FIG. 1 illustrates an overall system configuration of an LLM Twin system 100 according to one or more embodiments of the present disclosure, however, the present application is not limited thereto. The LLM Twin system 100 can include a Digital Twin 150, one or more Agents 110-140, and a user interface 200. FIG. 1 shows an example or hierarchy regarding how each element or component of the LLM Twin system 100 can be connected. In accordance with one or more embodiment of the present disclosure, the LLM Twin system 100 can include at least a Manager Agent 110, a Specialist Agent 120, at least one Line Agent 132 (e.g., for controlling assembly line(s)) and/or at least one Machine Agent 134, and one or more Equipment Agents 140 (i.e., Device Agent). As an example, an Agent can be assigned to each assembly line and can be assigned to each machine in a manufacturing facility, a factory or any other type of known facility. The LLM Twin system 100 is not limited to the Agents shown in FIG. 1, and may only comprise Manager Agent 110 and Equipment Agent 140. Optionally, the LLM Twin system 100 may or may not have one or more Specialist Agents 120 and/or may nor may not have one or more Line Agents 132 and/or one or more Machine Agents 134. According to one or more embodiments, the LLM Twin system 100 can have the same configuration or hierarchy as the actual system. Although FIG. 1 illustrates a hierarchy of Agents, including a hierarchy of Motion Agent 143 to Servo Drive Agent 144A to Servo Motor Agent 144B, embodiments of the present disclosure are not limited thereto and the LLM Twin system 100 may be provided without any hierarchy of Agents in part (e.g., within the Equipment Agents 140) or in whole.

Each Line Agent includes data (e.g., stored in data storage, such as memory or in the cloud) such as, but not limited to line design drawings, operation information and the like, and can be connected to a programmable logic controller (PLC) Agent 142 that controls and receives data from one or more PLCs. In addition, each Line Agent 132 can be connected to sensors and operable devices, such as motors, actuators, robotics and the like, which are used in the corresponding assembly line. The Equipment Agents 140 can include a PLC Agent 142 and can control Motion Agent 143, Servo Drive Agent 144A, Servo Motor Agent 144B, Machine Numerical Control (NC) Agent 145, Amplifier Agent 146, Machine Motor Agent 147 and the like. FIG. 1 illustrates “Motion” 143 which can refer to data from a motion sensor, including motion of an object, such as a conveyor belt, a component on a conveyor belt or any other motion associated with the facility. The PLC Agent 142 can store information on data storage (e.g., memory) regarding information on various equipment used in the facility. The information includes, but is not limited to, specification, manuals, programs (e.g., software programs), troubleshooting data, and the like.

The troubleshooting data can be updated with user information and information from the Specialist Agent 120, which provides know-how that is in supplement to the information the PLC stores. The supplemental information from the Specialist Agent 120 is stored in memory and can be trained on at least data regarding modification of settings that is divergent from the specifications in order to accommodate a particular machine, which may be the case when the particular machine has a high level of sensitivity and/or when the factory has vibration, sound or other type of interference that is skewing operation of the particular machine and request an alternation/change to its parameters. This information can be obtained by an operator, who determines, such as by trial and error or other means, that the settings provided in the specifications or manuals is not appropriate for a particular scenario. The Digital Twin 150 can include a current value (e.g., current specifications) of the equipment and historical data of the equipment, and can simulate variations, including in response to a user query or prompt to troubleshoot one or more machines.

Specialist Agent(s) 120 can communicate with any Lines/Machine Agents. The Specialist Agent(s) 120 can include a Troubleshooter Agent 122, a Data Analyst Agent 124 and a Programmer Agent 126. The Troubleshooter Agent 122 can provide various troubleshooting examples, the data analyst can provide data analysis methodology and the programmer can provide program identification. The Troubleshooter Agent 122 can communicate with the Line Agent 132 to determine how to resolve an issue, such as an error or other problem with machinery. The Programmer Agent 126 can communicate with the Machine Agent 134, and can communicate with the Motor Agent 147, the Amplifier Agent 146, the NC Agent 145 or other control device, or any other component to program their functions. For instance, the Programmer Agent 126 may alter a specification in a program used to run a particular machine or equipment based on troubleshooting examples or other information.

Hereinafter, “data” can refer to any type of information, such as records or values, that are collected, stored, processed, or analyzed within the LLM Twin system 100. The data can include various types of information, such as images, video, audio, text, numbers, and the like. Herein, the term “models” refer to representations, algorithms, or mathematical formulations designed to predict, describe, or analyze real-world phenomena based on input data. In this regard, the processing arrangement takes input from the plurality of autonomous agents within the LLM Twin system, which includes data and/or models associated with their respective functionalities. The data comprises information required by the autonomous agents to perform a task to fulfil a service request. The models encompass various attributes, parameters, and characteristics that define the behavior and capabilities of the plurality of autonomous agents. Optionally, by leveraging the information gathered, the processing arrangement employs algorithms and similarity metrics to identify the plurality of autonomous agents that exhibit substantial commonalities in terms of their attributes, domain of operation, and task-specific parameters.

Data can be obtained from various sensors, machinery and components of a manufacturing plate or building facility, and can be obtained through software such as GENESIS64® or other type of Supervisory Control and Data Acquisition (SCADA) software which provides connectivity from plant floor and building facilities to corporate business systems. The SCADA software can be designed to leverage 64-bit platforms and OPC Unified Architecture (OPC UA) technologies, to allow operators (e.g., user) and the like to integrate real-time manufacturing, energy, and business information into a secure and unified visualization dashboard (i.e., user interface) that can be web-enabled. Such SCADA software can act as a simulation of components of a factory, such as machinery, a PLC other apparatus, to allow for various adjustments and/or repairs to be made to determine their effectiveness, such as in response to a query and can work and/or function as the Digital Twin 150. For instance, a user may initiate a query regarding the addition of a feature to a piece of machinery, or adding capabilities to an assembly line (i.e., that is already in use). The SCADA software can, together with various Agents of the LLM Twin System 100, determine whether such an addition is feasible and/or even possible and relay that information, such as via a Manager Agent 110, to the user. The Manager Agent 110 can receive information from the various Agents to determine an answer to any query presented by a user, and can make its own determination based on the information.

The dashboard can be designed by a Human-Machine Interface (HMI) such as GraphWorX64™, which can display real-time data from various sources, such as sensors, programmable logic controller (PLCs), and other devices. The user interface may be an HMI, which can include a text input prompt that allows a user to add text in the form of data and/or questions and can answer questions based on information retrieved from one or more Agents.

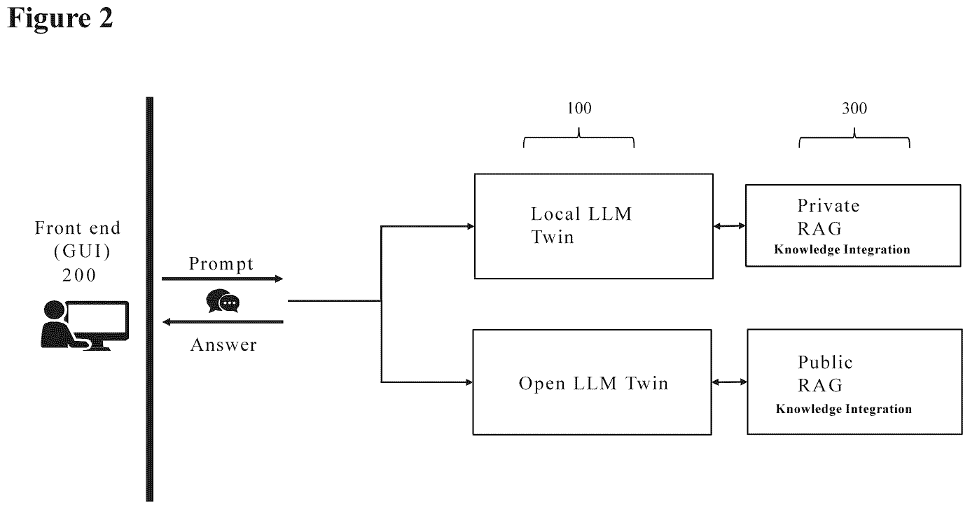

FIG. 2 illustrates an internal architecture of a representative Agent (e.g., Device Agent, Machine Agent, etc.), showing how the LLM Twin system 100, tool execution capabilities, and memory functions are integrated. A user interface (UI) 200 (i.e., a front end graphical user interface (GUI)) can be provided, which includes a prompt for a user to enter an query, such as via a text input on a keyboard or other input device, an audio input via a microphone, or the like, regarding factory automation, building management, a component of a building and/or factor. For instance, the user may inquire regarding how a particular device operates, is assembled, is disassembled or may pose a troubleshooting inquiry. In addition, the query may be in the form of a question to be answered by the system, for instance, the question may include data regarding one or more elements (e.g., components) of the system and how they are operating and may ask how to fix the elements and/or ask if the elements are operating properly.

A user can select either a Local LLM Twin System 100 or an Open LLM Twin System 100. A Local LLM refers to an LLM in a closed network that is not connected (i.e., isolated) to the outside (i.e., outside internet), such as a local area network (LAN), such as shown in FIG. 2. An Open LLM refers to an LLM in an open network that is connected to the outside (i.e., via the internet or other communication method). RAG is a technique that enhances the capabilities of large language models (LLMs) by allowing them to access and incorporate information from external knowledge bases. This empowers LLMs to provide more accurate, relevant, and up-to-date responses to user inquiries. RAG indexes an external knowledge base, which can be a collection of documents, articles, or other text-based information. The indexing involves converting the text into numerical representations (i.e., embeddings) that can be understood by the LLM. Then the RAG retrieves the most relevant documents from the knowledge base based on a determined similarity to the original query. Then the retrieved documents are combined with the original query to form a new prompt that is augmented, and this augmented prompt is fed into the corresponding LLM(s). Finally, the corresponding LLM(s) process the augmented prompt and generate a response that includes information from the original query and the retrieved documents. Similar to the LLM Twin System 100, the RAG 300 can be a local or a private RAG 300 that is within a closed network that is not connected (i.e., isolated) to the outside (i.e., outside internet), such as a local area network (LAN) or can be a public RAG 300 that is within an open network that is connected to the outside (i.e., via the internet or other communication method), such as the configuration shown in FIG. 2.

Each of the Local LLM Twin System 100 and the Open LLM Twin System 100 include at least memory, circuitry (e.g., hardware-embedded processor/CPU) and tools, such as sets of resources and frameworks for tailored creating models. Key tools and resources associated with LLM Twins including frameworks and libraries, data and tools for model training, deployment and infrastructure, as known in art. Frameworks and library include, but are not limited to hugging face transformers, which provides tools for training, fine-tuning, and deploying models, LangChain, which is a framework for building applications powered by language models to connected LLMs to data and APIs, and provide tools for prompt engineering, vector databases, and more, LlamaIndex, which is a framework for building semantic search applications powered by LLMs to help index and query large datasets of text and code, and can be used to create custom knowledge bases and chatbots, and the like. Data and tools for model training includes datasets and data labeling tools. The LLM twins can be used for a variety of applications, such as chatbots and virtual assistants, content generation, summarization, translation and code generation.

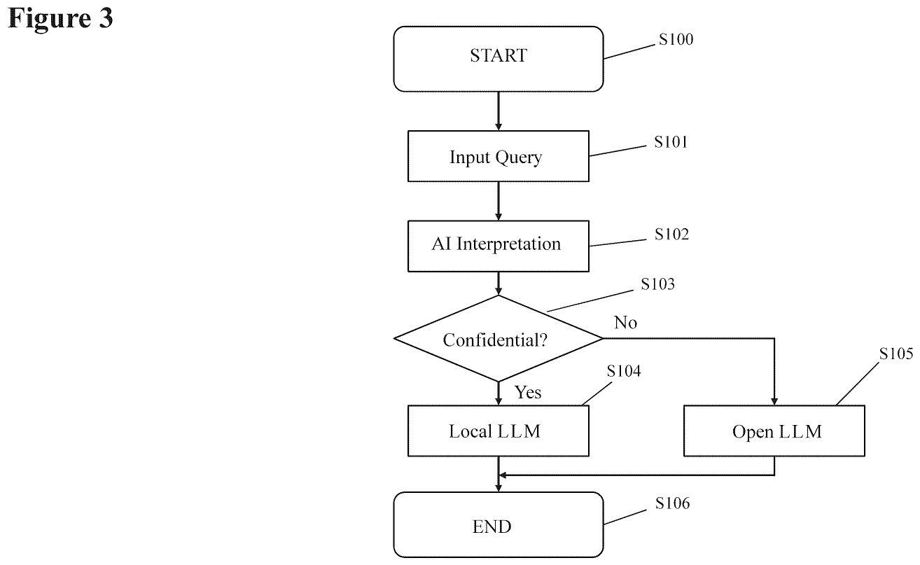

FIG. 3 illustrates an LLM Switching Flowchart diagram showing the flow of switching between Local LLMs and Open LLMs via the user interface, including the operation of the AI-based primary decision-making system. In FIG. 3, at S100 the process is started with an input prompt, such as a query by a user via a user interface as described above. At S102, the query is interpreted by the Agent, such as a Manager Agent 110. The Manager Agent 110 can confirm the interpretation by presenting a prompt or question to the user. For instance, the Manager Agent 110 can interpret the query and ask the user whether the interpretation is correct. That is, if the query is not clear to the Manager Agent 110 or other Agent, the Manager Agent 110 or other Agent can ask the user to clarify the query and/or can consult with other Agents to determine if the query is clear by collecting relevant information. The consulting of the other Agents can include asking the other Agents whether more information from the user is required or if the query is sufficiently clear. At S103, the Manager Agent can determine whether the query represents confidential information (i.e., information not for public consumption). Confidential information can include proprietary information, such as manufacturing processes, materials or other information. At S104 if the information is determined to be confidential, a Local LLM system 100 is used, and at S105 if not determined to be confidential an Open LLM 100 is used. Then the process ends.

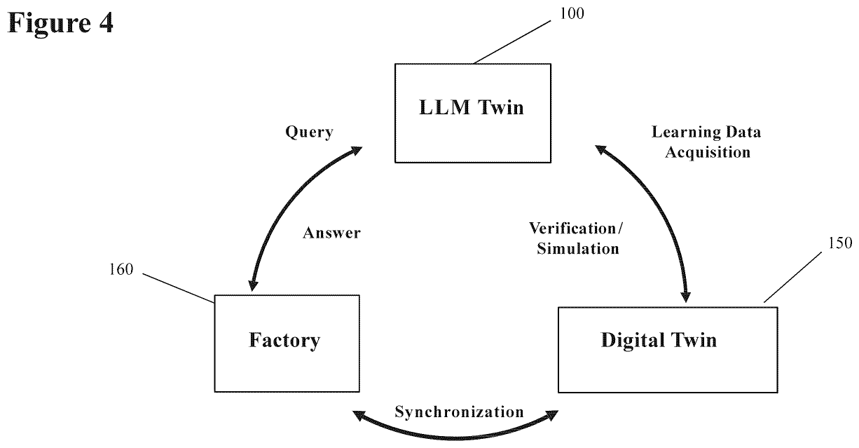

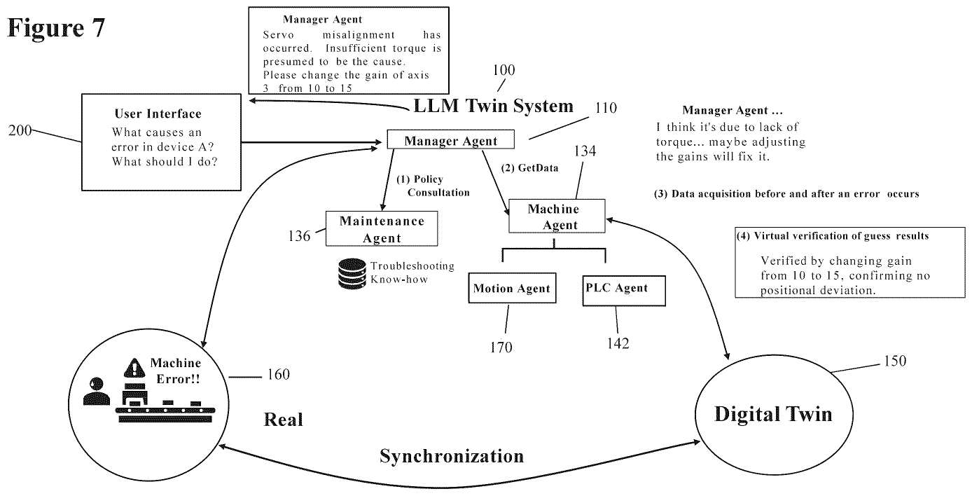

FIG. 4 is a flow chart of the interaction between “Factory” 160 (a factory, manufacturing facility or other facility), an LLM Twin system 100 and a Digital Twin 150. As illustrated in FIGS. 4 and 7, the Digital Twin 150 can be synchronized with the Factory 160, including digital and physical (e.g., mechanical) components of the Factory 160. This includes the Digital Twin monitoring, in real-time, the Factory to predict potential problems, correct existing problems, and/or determine ideal (i.e., optimum) operating conditions. Data from the Factory 160, including data obtained from different machinery and/or equipment of the factory (or any other facility) can be synchronized with the Digital Twin 150. In response to a user inputting a query, the LLM Twin System 100 analyses and can reword the query to better match an outlook and send the updated query or a related prompt to the Digital Twin 150. The LLM Twin system 100 can cause the Digital Twin 150 to perform simulations to determine an answer to the query. For instance, the Digital Twin 150 can perform simulations by changing parameters of the machine/device related to the query, and upon determining a solution, send the proposed parameter change to the LLM Twin System 100, which can indicate a parameter change as part of the solution, by sending the information to the user interface for the user to view.

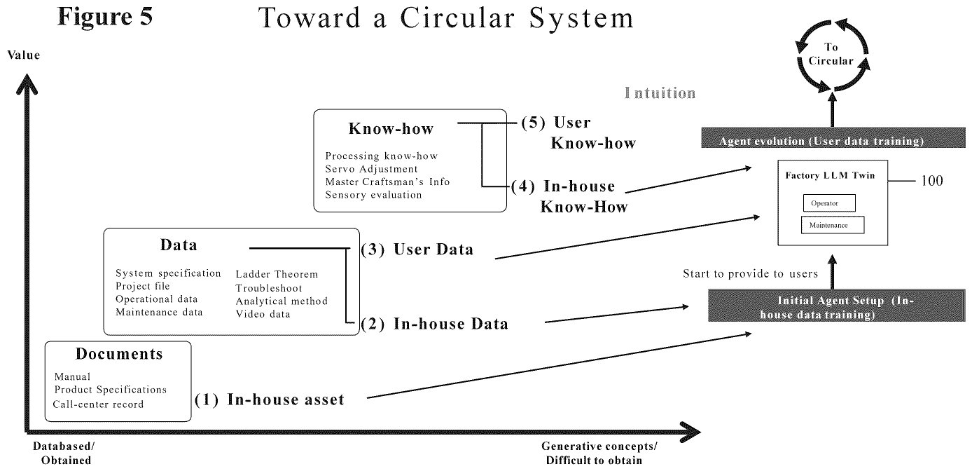

FIG. 5 illustrates the lifecycle of Agent evolution, including how initial Agents are set up and evolve by incorporating user data over time. Initially, Agents are set up using in-house data training, including using documents for various components, such as a PLC, servo, a machine, sensors and the like. Documents include, but are not limited to, manuals, product specifications, call-center records and the like, and other in-house data such as system specification, project files, operational data and maintenance data. This in-house data can be used to initially train and/or set up an Agent. User data, such as troubleshooting data provided to or by a user, video data of operating a device and the like, and analytical data such as patterns are trends can be designated a user data training, can be inputted into an LLM Twin System 100 (e.g., Factory LLM Twin) and used to further train the Agent(s). In addition, operator know-how (e.g., skilled worker information), such as processing know-how, servo adjustment, master craftsman information, sensory evaluation and the like can also be transmitted to the LLM Twin System 100 to further train the Agent(s).

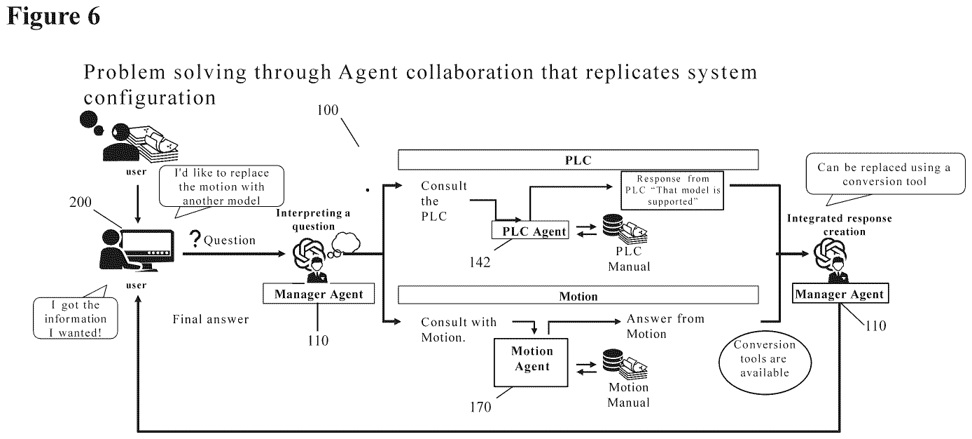

FIG. 6 illustrates a diagram of problem solving using an LLM Twin system according to one or more embodiments of the present application. A user can input a query through a user interface, such as a request for information regarding a particular process. FIG. 6 illustrates a request for information regarding motion data for a different model or a new model or a component. In the LLM Twin system 100, a Manager Agent 110 can interpret the question/query, and can consult with a Motion Agent 170 and with a PLC Agent 142. The PLC Agent 142 can search for an answer to the query from data, such as a PLC manual and the like. In FIG. 6, the PLC Agent 142 determines that the model indicated in the query is supported, and determines whether the new model is supported. This determination by the PLC Agent 142 is sent/transferred to the manager Agent. In addition, the Motion Agent 170 can search for an answer from data, such as a motion manual and the like, to determine how the new model is supported. This determination by the Motion Agent 170 includes determining whether conversion table or other means to use the new model are available, and the Motion Agent 170 can send this information to the Manager Agent 110. The Manager Agent 110 then provide an answer to the user, via the user interface. In this instance, the PLC Agent 142 determines that the new model is supported, and the Motion Agent 170 determines that the conversion table is available, and this information is relayed by the Manager Agent 110 via the user interface, for example, by text, audio, video and the like.

FIG. 7 illustrates a diagram of a process troubleshooting an error in a device/machine according to one or more embodiments of the present application. For instance, a device in a manufacturing facility be faulty with an error, and a user (e.g., via the user interface) can ask the LLM Twin System 100, via the Manager Agent 110, what could cause that particular error to the device and what can be done to correct or mitigate the error. The Manager Agent 110 can consult a Maintenance Agent 136 to communicate with the device having the error to determine possible solutions to the error including determining if troubleshooting information is available. FIG. 7 illustrates the error being a servo misalignment possibly due to insufficient torque, and the Manager Agent can determine an initial estimation of a correction of the error (“please change the gain of axis 3 from 10 to 15”). This initial correction information can be communicated from the Maintenance Agent 136 to the Manager Agent 110, and can further be communicated to and from the Manager Agent 110 to a Machine Agent 134. The Machine Agent 134 can include or separately communicate with a Motion Agent 170 and/or a PLC Agent 142.

The Machine Agent 134 can acquire data of the machine from before the error occurred and after the error occurred, and can send this information, together with troubleshooting information, to a Digital Twin 150. The Digital Twin 150, which can be synchronized with the Factory, including all of its components/devices, can simulate one or more possible solutions based on synchronized data from the Factory, information from the Maintenance Agent 136, information from the Manager Agent 110, and the like, to determine which solution is most feasible (i.e., optimal). Upon determining one or more solutions, the Digital Twin 150 can provide the one or more solutions to the Manager Agent 110, and the Manager Agent 110 can provide this solution to the user via the user interface. FIG. 7 illustrates a “virtual verification of guess results,” in which the Digital Twin simulates the initial estimation by the Manager Agent 110 and/or Maintenance Agent 136, and determines whether the initial estimation is correct (“verified by changing gain from 10 to 15, confirming no positional deviation”) and then communicates this information either directly to the Manager Agent 110, or to the Manager Agent 110 through the Machine Agent.

As discussed above with respect to FIG. 4, the Digital Twin 150 can be synchronized with the Factory 160, including digital and physical (e.g., mechanical) components of the Factory 160. That is, users connected to the Digital Twin (i.e., digital factory) can interact with the digital environment, and the Digital Twin can synchronize with the Factory to access real-time information about the status of the Factory 160, such as data from machines and/or devices and/or lines and/or personnel and any other data from the Factory. This data from the Factory is stored (i.e., collected) into memory and is sent to the Digital Twin (i.e., Digital Twin factory), where real-world factory conditions are reproduced/replicated in the digital environment, allowing for real-time monitoring. Within the Digital Twin, the status of devices (i.e., machines) and facilities can be visually observed using 3D modeling, and all data generated in the real-world factory are implemented in the Digital Twin (i.e., digital factory).

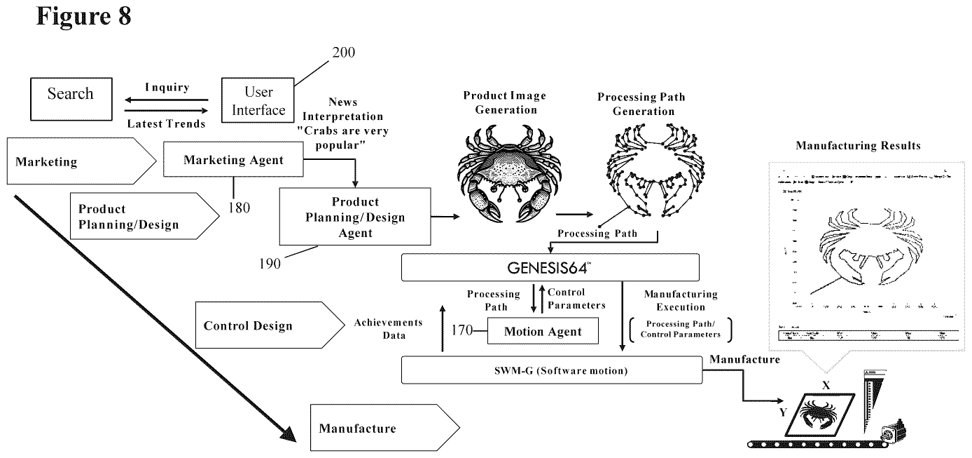

FIG. 8 illustrates a flowchart of automatically determining a product to be produced based on market trends. First, an inquiry is presented, and market trends are searched and determined, which is inputted into a Marketing Agent 180. The Marketing Agent 180 can gather information from various sources, such as the internet, to determine a current trend, such as a trendy product to be produced. Once a product is selected, a Product Planning/Design Agent 190 is used to create a design protocol, including each of the steps to manufacture the product. The Product Planning/Design Agent 190 may create a plurality of designs, and present those either to a user, or may select the best design based on its own determination. This selected design can then be inputted into a Motion Agent 170, which controls various equipment in a manufacturing facility, including the processing path(s) and control parameters through SCADA software such as GENESIS64® and/or motion control software such as SWM-G®. Motion control software is designed to control multi-axis machines and supports various types of motion control, such as positioning, synchronous, cam, speed, and torque control. For instance, SWM-G provides multi-axis control that can supports up to 128 axes, enabling control of complex machine, network control to allows for the connection and control of various devices, including remote I/O modules and TCP/IP devices, real-time performance with high-precision and reliable motion control with real-time capabilities and compatibility with various types of components, such as but not limited to motion control products, including servo drives and motion controllers. SWM-G can be used in various industries, including automotive, electronics, and machinery manufacturing, for applications such as assembly, packaging, and material handling.

According to one or more embodiment of the present invention, troubleshooting equipment errors in a Factory can include constructing an LLM Twin System 100 with Agents based on the actual system configuration of the factory, to provide high-accuracy solutions in a short period of time. For example, a situation where a user inquiries about the cause and solution for an equipment alarm that has occurred in a factory. Upon receiving the user's query, the Manager Agent 110 can examine the task and consults with the Maintenance Agent 136 that has troubleshooting expertise to develop a solution.

According to one or more embodiment of the present invention, a Maintenance Agent 136 utilizes its knowledge to formulate a plan for retrieving relevant data from the Digital Twin 150 and verifying it via simulation and reports the approach to the Manager Agent 110.

According to one or more embodiment of the present invention, the Manager Agent 110 accesses the Digital Twin 150 via the Machine Agent 134 or Device Agent, acquires related data before and after the alarm occurs, and analyzes it to infer the cause of the alarm. In more advanced cases, this operation can be performed by the Data Analysis Agent. Based on these results, the Manager Agent 110 devises a plan to modify relevant parameters. According to one or more embodiment of the present invention, the Manager Agent 110 can then access the Digital Twin 150 again to create a virtual environment, modifies the parameters, and after confirming the parameters would resolve the alarm/issue, the system provides the user with an example of parameter changes to resolve the alarm.

According to one or more embodiment of the present invention, troubleshooting equipment errors in a building can include constructing an LLM Twin System 100 with Agents based on the actual system configuration of the building, to provide high-accuracy solutions in a short period of time. For example, a user inquiries about the cause and solution for an equipment alarm in a building. Upon receiving the user's query, the Manager Agent 110 examines the task and consults with the Maintenance Agent 136 that has troubleshooting expertise to develop a solution. The Maintenance Agent 136 can use its knowledge to formulate a solution based on past cases and reports it to the Manager Agent 110. Then, Manager Agent 110 can access the Digital Twin 150 via the Air Conditioning Agent, Lighting Agent, Elevator Agent, or any other Agent related to a component of the building, retrieve data related to the alarm before and after its occurrence, and conduct an analysis to estimate the cause of the alarm. In more advanced cases, this operation can be performed by the Data Analysis Agent. Based on these results, the Manager Agent 110 can devise a plan to modify relevant settings. The Manager Agent 110 can then access the Digital Twin 150 again to create a virtual environment, modify the settings, and run a simulation to verify that the alarm issue is resolved. After confirming this, the system provides the user with an example of setting changes to resolve the alarm.

The following configuration examples also fall within the technical scope of the present disclosure.

(1) A system according to one or more embodiments of the present application in which multiple Agents using multiple Large Language Models (LLMs), designed based on the actual system configuration of factories and facilities, work together. This has an effect of providing necessary and optimal solutions tailored to the actual system configuration of individual users, enabling rapid deployment without customization. By enabling Agents to communicate (e.g., consult, debate, request, verify, vote, divide roles, report, propose), advanced problem-solving can be achieved.

(2) The system of (1), wherein the system combines real-time data from factories and facilities with Digital Twin technology to support advanced problem-solving in manufacturing and facility management. This has an effect of allowing for data analysis and simulation verification before generating responses for troubleshooting, supporting decision-making and improving both startup efficiency and operational efficiency.

(3) The system of (1), wherein the system is applied to factory management and includes Device Agents, Machine Agents, Line Agents, Factory Agents, and Manager Agents. Each Agent has different roles and authority, allowing efficient problem-solving within their respective areas using relevant data, knowledge, and tools. This improves overall factory and equipment management, enhancing both startup efficiency and operational efficiency. Furthermore, the clear definition of each Agent's responsibilities simplifies management.

(4) The system of (3), wherein each Agent has distinct characteristics, and the manager Agent emphasizes flexibility and creativity while the Device Agent emphasizes accuracy, to achieves a balance between creativity and accuracy in the system.

(5) The system of (3), wherein the Line Agent and Machine Agent have customization functions tailored to specific customer needs to enhance the system's flexibility by customization to meet user requirements.

(6) The system of (1), wherein initial Agents are created based on internal documents and data and evolve by collecting user data. By incorporating actual user data, the system's capabilities continuously improve and become more effective over time.

(7) The system of (1), wherein it is applied to office building management and includes Air Conditioning Agents, Lighting Agents, Elevator Agents, Building Agents, and Manager Agents. Effect: Each Agent has different roles and authority, allowing efficient problem-solving within their respective areas using relevant data, knowledge, and tools. This makes managing the building and equipment easier, improving both startup efficiency and operational efficiency. Additionally, the clear definition of each Agent's responsibilities simplifies management.

(8) The system of (3) or (7), wherein it includes specialist Agents that utilize the know-how of experienced technicians. Introducing Specialist Agents enables advanced problem-solving using specialized knowledge, improving the system's overall accuracy and reliability.

(9) The system of (1), wherein it provides an interface that allows users to switch between local LLMs and open LLMs, in order for users to flexibly choose between local LLMs to minimize data leakage risks or open LLMs for solving more complex problems.

(10) The system of (9), wherein local LLMs are processed entirely within an environment managed by the company or system provider. By processing local LLMs within a managed environment, data security is enhanced, ensuring the safe handling of confidential information.

(11) The system of (9), wherein an AI-based primary decision-making system automatically selects either the local LLM or open LLM based on the user's query. By automatically selecting the optimal LLM based on the query, user operation is simplified, and system efficiency and security are improved.

(12) The system of (9), wherein the database used is automatically determined based on the selected LLM. When using local LLMs, a database containing confidential information is selected, and when using open LLMs, a database without confidential information is selected, ensuring data security.

(13) The system of (1), wherein it retrains by combining data collected from multiple users, to accelerate the enhancement of each Agent's capabilities.

(14) The system of (13), wherein user data is converted into metadata to prevent information leakage to other users to ensure user security and privacy.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

Various embodiments described herein may be implemented in a computer-readable medium using, for example, software, hardware, or some combination thereof. For example, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A large language model (LLM) twin system, comprising:
a user interface configured to receive a query from a user;
a Digital Twin configured to simulate each of a plurality of devices of a factory; and
a plurality of LLM Agents, including a Manager Agent configured to communicate with other LLM Agents among the plurality of LLM Agents and the Digital Twin,
wherein in response to a user inputting the query into the user interface, the Manager Agent is configured to:
interpret the query using one or more of the other LLM Agents to update the query,
send the updated query to one or more of the other LLM Agents to receive an answer to the query,
receive the answer from the one or more other LLM Agents, and
send the answer to the user through the user interface.

2. The LLM twin system of claim 1, wherein
in response to the query being related to a function of one of the plurality of devices of the factory, the Manager Agent is configured to request the Digital Twin to simulate the answer from the one or more LLM Agents to verify the answer, and
in response to the Digital Twin verifying the answer by performing a simulation of the answer, the Digital Twin is configured to send the answer to the Manager Agent.

3. The LLM twin system of claim 2, wherein
the query is related to an error of a first device among the plurality of devices,
the answer is a change to parameters of the first device, and
the Digital Twin is configured to:
simulate the change to the parameters of the first device and determine whether the change to the parameters corrects the error,
in response to the error not being corrected, simulate updated parameters until the error is resolved, and
send the updated parameters to the user interface via the Manager Agent.

4. The LLM twin system of claim 1, wherein
the Manager Agent is configured to determine the Agent among the plurality of Agents that can answer the query,
the query relates to one of the plurality of devices, and
the Manager Agent is further configured to update parameters of the device based on the determined answer.

5. The LLM twin system of claim 1, wherein the Manager Agent is configured to provide a prompt to the user through the user interface if the query is too vague, the prompt including a request to rephrase the query.

6. The LLM twin system of claim 1, wherein
the Manager Agent is configured to calculate an initial answer and then send the initial answer to the one or more of the plurality of LLM Agents and to the Digital Twin for confirmation, and
the Digital Twin is configured to:
perform a simulation of the initial answer and other possible answers, and determine adjustments to a device among the plurality of devices needed to obtain the updated answer, and
send the answer to the Manager Agent.

7. The LLM twin system of claim 6, wherein
the one or more other LLM Agents are trained based on in-house data and user data,
the in-house data including at least one of operational data, maintenance data, and system specifications, and
the user-data including at least one of troubleshooting data and project files.

8. The LLM twin system of claim 1, wherein
the plurality of LLM Agents further includes a Specialist Agent, a Machine Agent and a Line Agent,
the Specialist Agent is configured to be trained on data regarding modification of settings from specifications in order to operate the plurality of devices,
the Machine Agent is configured to store and analyze data from each of the plurality of devices to optimize operation of the plurality of devices, and
the Line Agent is configured to manage an entire production line of the factory and to optimize productivity in real-time.

9. The LLM twin system of claim 1, wherein the Manager Agent is configured to determine whether to use an open LLM system or a closed LLM system to answer the query by the user by:
interpreting the query,
determining whether the query relates to confidential information,
using an open LLM if the query does not relate to confidential information, and
using the closed LLM if the query does relate to confidential information,
the closed LLM being a closed internal network, and
the open LLM being an open network that is connected to outside of the internal network.

10. The LLM twin system of claim 1, further comprising RAG (Retrieval Augmented Generation) configured to provide the LLM twin system data from external knowledge databases,
wherein the RAG is configured to:
index the external knowledge base by converting text into numerical representations that can be understood by the LLM twin system,
retrieve the most relevant documents from the external knowledge base based on a determined similarity to the query, and
combine the retrieved documents with the query to form a new query that is augmented and this augmented query is fed into the plurality of LLM Agents.

11. A large language model (LLM) twin system, comprising:
a user interface configured to receive a query from a user;
a Digital Twin configured to simulate each of a plurality of devices of a factory; and
a plurality of LLM Agents, including:
a Manager Agent configured to communicate with other LLM Agents among the plurality of LLM Agents and the Digital Twin, and
a Motion LLM configured to control the plurality of devices in the factory, including the processing path(s) and control parameters through Supervisory Control and Data Acquisition (SCADA) software,
wherein in response to a user inputting the query into the user interface and the query being a request for manufacturing plans for an item to produce, the Manager Agent is configured to:
search and determine the item to produce,
automatically produce a product design based on the determined item, including forming a process image,
transfer the product design to the Motion LLM to generate a processing path,
receive the processing path from the Motion LLM, and
use the generated product design and processing path to produce the product in the factory.

12. The LLM twin system of claim 11, the Manager Agent is further configured to interpret the query using one or more of the other LLM Agents to update the query.

13. The LLM twin system of claim 12, wherein the Manager Agent is further configured to provide a prompt to the user through the user interface if the query is too vague, the prompt including a request to rephrase the query.

14. The LLM twin system of claim 11, wherein
the plurality of LLM Agents further includes a Specialist Agent, a Machine Agent and a Line Agent,
the Specialist Agent is configured to be trained on data regarding modification of settings from specifications in order to operate the plurality of devices,
the Machine Agent is configured to store and analyze data from each of the plurality of devices to optimize the operation of the plurality of devices, and
the Line Agent is configured to manage an entire production line of the factory and to optimize productivity in real-time.

15. The LLM twin system of claim 11, wherein the Manager Agent is configured to determine whether to use an open LLM system or a closed LLM system to answer the query by the user by:
interpreting the query,
determining whether the query relates to confidential information,
using an open LLM if the query does not relate to confidential information, and
using the closed LLM if the query does relate to confidential information,
the closed LLM being a closed internal network, and
the open LLM being an open network that is connected to outside of the internal network.

16. A large language model (LLM) twin system, comprising:
a user interface configured to receive a prompt from a user;
a Digital Twin configured to simulate each of a plurality of devices of a factory; and
a plurality of LLM Agents, including:
a Manager Agent configured to communicate with other LLM Agents among the plurality of LLM Agents and the Digital Twin;
a Specialist Agent;
a Machine Agent; and
a Line Agent, wherein
the Specialist Agent is configured to be trained on data regarding modification of settings from specifications in order to operate the plurality of devices,
the Machine Agent is configured to store and analyze data from each of the plurality of devices to optimize operation of the plurality of devices,
the Line Agent is configured to manage an entire production line of the factory and to optimize productivity in real-time, and
in response to the user inputting the query into the user interface, the Manager Agent is configured to:
interpret the query using one or more of the other LLM Agents to update the query;
send the updated query to one or more of the other LLM Agents to receive an answer to the query,
in response to the query being related to a function of one of the plurality of device of the factory, request the Digital Twin to simulate the answer from the one or more other LLM Agents to verify the answer, and
receive the verified answer from the Digital Twin and send the verified answer to the user through the user interface.

17. The LLM twin system of claim 16, wherein
the Manager Agent is configured to calculate an initial answer and then send the initial answer to the one or more other LLM Agents and the Digital Twin for confirmation, and
the Digital Twin is configured to:
perform a simulation of the initial answer and other possible answers, and determine adjustments to a device among the plurality of devices needed to obtain the updated answer, and
send the answer to the Manager Agent.

18. The LLM twin system of claim 17, wherein the Manager Agent is configured to provide a prompt to the user through the user interface if the query is too vague, the prompt including a request to rephrase the query.

19. The LLM twin system of claim 16, wherein the Manager Agent is configured to determine whether to use an open LLM system or a closed LLM system to answer the query by the user by:
interpreting the query,
determining whether the query relates to confidential information,
using an open LLM if the query does not relate to confidential information, and
using the closed LLM if the query does relate to confidential information,
the closed LLM being a closed internal network, and
the open LLM being an open network that is connected to outside of the internal network.

20. The LLM twin system of claim 16, further comprising RAG (Retrieval Augmented Generation) configured to provide the LLM twin system data from external knowledge databases,
wherein the RAG is configured to:
index the external knowledge base by converting text into numerical representations that can be understood by the LLM twin system,
retrieve the most relevant documents from the external knowledge base based on a determined similarity to the query, and
combine the retrieved documents with the query to form a new prompt that is augmented and this augmented prompt is fed into the plurality of LLM Agents.
